(19) United States
(12) Patent Application Publication
(10) Pub. No.: US 2002/0066787 A1
(43) Pub. Date: Jun. 6, 2002

(54) Radio frequency/direct wired connection for bar code scanner

(76) Inventors: Cedric Mollon, Toulouse (FR); Christophe Duthil, Toulouse (FR); Patrice Thebault, Toulouse (FR); Jean-Louis Massieu, Montanban (FR)

Correspondence Address: Orum & Roth, 53 West Jackson Boulevard, Chicago, IL, 60604, US

(21) Appl. No.: 09/907,286

(22) Filed: Jul. 17, 2001

Related U.S. Application Data
(60) Provisional application No. 60/218,630, filed on Jul. 17, 2000.

(51) Int. Cl. G06K 7/10; G06K 7/14

(52) U.S. Cl. 235/454

(57) ABSTRACT

A hand held scanner with a single multi-conductor cable supplying both power and data conductors. When connected, the cable supplies power for operation and or charges a local power supply in the scanner. Data conductors in the cable transmit scanned data to a host processor allowing continuous operation even in noisy RF environments that may inhibit RF communication between RF transmitters which may be supplied in the scanner and host processor.

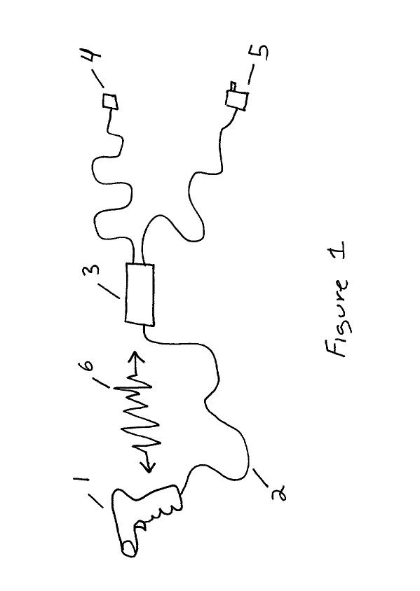

This invention claims the benefit of U.S. Provisional Application No. 60/218630, filed Jul. 17, 2001.

### BACKGROUND OF THE INVENTION

1. Field of the Invention

The invention is in the field of scanners, more specifically to scanners with a single, integrated, power and data connection.

2. Description of Related Art

The invention simplifies bar code scanners by integrating the power supply and the data connection into a single line. Prior bar code/data scanners utilized separate charging and communication functions or a dock-style charger which increased cost. Previous scanners included a cable for power supply and/or battery recharging and a separate cable for communications.

### SUMMARY OF THE INVENTION

The present invention integrates the communications and power supply/charging scanner utility into a single connecting cable.

The handheld scanner of the present invention has Radio Frequency (RF) capability. RF capability is useful for scanning objects where the label to be scanned is difficult to access, where a cable would create a safety hazard, or where the scanner is required to be moved further then the cable will reach in order to make the scan. To minimize the costs and power requirements, the RF transceiver in the scanner and in the interface box are of low power and low power consumption. A local power storage device, for example one or more rechargeable battery in the scanner enables use of the scanner separated from the cable for an extended period, for example eight hours, or it may be used with the cable attached continuously. In one embodiment, with the cable attached, the RF function is disabled, and communication is made through the cable. This feature is useful where radio frequency interference is an intermittent problem.

A major advantage of the invention is that the ergonomic advantage and freedom of using the bar code scanner without any cable attached is made available to the user. However, the cost of additional connections to the bar code scanner for charging or a docking charging station or the size of the scanner being very large due to a large battery is all unnecessary. The hybrid use of the connection between the bar code scanner and the interface box allows both portable and radio frequency use with a minimum of additional components necessary to achieve that operation, creating cost savings and ergonomic advantages for the user.

### DESCRIPTION OF THE DRAWINGS

The figure shows a schematic view of one embodiment of the invention.

### DETAILED DESCRIPTION

The present invention simplifies power and data connections to the scanner. The invention is usable with any form of scanner, for example, hand held or body mounted scanners. The scanner may be any form of machine readable data acquisition device. Examples of scanners visible with the invention include optical bar code and other one and/or two dimensional symbology scanners, RFID interogators, magnetic readers, or combination scanners capable of multiple format data acquisition, for example, optical and RFID.

As shown in the figure, a handheld scanner 1 has an RF transceiver and battery. The scanner 1 has a detachable cable 2 which links the scanner 1 to an interface box 3. The cable 2 has both power and data communication connections. The scanner 1 may be powered or charged through the cable 2 and also communicates scanner data through the cable 2. When the cable 2 is detached, the scanner 1 operates from battery power, transmitting data via the RF Transciever by RF 6 to the RF transceiver in the interface box 3. The RF transmission protocol may be, for example, Bluetooth, Home RF, IEEE 802.11 or Proprietary. Interface box 3 has a power connection 5. A power supply may be installed into the interface or a Hatched remotely at the end of the connection 5. Also, the interface box 3 has a host connector 4 for communication of the data to a host processor.

The connectors to the host processor and the local power source may be combined into a single Universal Serial Bus (USB) connection to the host processor. In a further embodiment, the interface box may be mountable within the housing of the host processor, for example, a desktop computer, eliminating the need for separate connection/cabling 4 and 5.

The present invention is entitled to a range of equivalents, and is to be limited in scope only by the following claims.

We claim:

1. A scanner power and data connection system, comprising:
a scanner,
a cable with a plurality of power and data conductors, and
an interface device;
the cable connects the scanner to the interface device;
the interface device connectable to a host processor and a power source.

2. The system of claim 1, wherein:
the scanner has a first RF transceiver and a local power storage device;
the interface device has a second RF transceiver;
the scanner operable via the local power storage device power with data communication via RF between the first and second RF transceivers.

3. The system of claim 2, wherein:
the scanner data communication is selectively operable via one of RF and cable.

4. The system of claim 2, wherein:
the interface device has a USB connection to the host processor; the USB connection supplying both a power source connection and a host processor data communication connection.

5. The system of claim 4 wherein the interface device is replaced by a USB connection between the scanner and the host processor;
the host processor housing the second RF transceiver.

6. A scanner power and data connection system, comprising a means for scanning:
a cable having power and data conductors; and
an interface device;
the cable connects the scanner to the interface device;
the interface having means for connection with a host processor and a power source.
